(19) United States
(12) Patent Application Publication
(10) Pub. No.: US 2013/0311724 A1
(43) Pub. Date: Nov. 21, 2013

(54) CACHE SYSTEM WITH BIASED CACHE LINE REPLACEMENT POLICY AND METHOD THEREFOR

(71) Applicants: William L. Walker, Fort Collins, CO (US); Robert F. Krick, Longmont, CO (US); Tarun Nakra, Austin, TX (US); Pramod Subramanyan, Princeton, NJ (US)

(72) Inventors: William L. Walker, Fort Collins, CO (US); Robert F. Krick, Longmont, CO (US); Tarun Nakra, Austin, TX (US); Pramod Subramanyan, Princeton, NJ (US)

(73) Assignee: ADVANCED MICRO DEVICES, INC., Sunnyvale, CA (US)

(21) Appl. No.: 13/473,778

(22) Filed: May 17, 2012

(51) Int. Cl. G06F 12/12

(52) U.S. Cl. 711/136; 711/E12.071

(57) ABSTRACT

A cache system includes plurality of first caches at a first level of a cache hierarchy and a second cache at a second level of the cache hierarchy which is lower than the first level of cache hierarchy coupled to each of the plurality of first caches. The second cache enforces a cache line replacement policy in which the second cache selects a cache line for replacement based in part on whether the cache line is present in any of the plurality of first caches and in part on another factor.

### FIELD

This disclosure relates generally to a cache s stem, and more particularly to a cache system with a cache line replacement policy.

### BACKGROUND

Currently state-of-the-art processors (e.g., central processing units, graphics processing units, application processors, accelerated processing units, etc.) are designed with multiple caches, which store copies of data from the most frequently used main memory locations in order to reduce look-up time. Because a microprocessor's performance is affected by the average memory access time, inclusion of frequently used data in a local, high-speed cache greatly improves overall processing speed.

Today, many processors include multiple processor cores or elements (the nomenclature frequently depending upon the type of processor) with both local and shared caches organized in a cache hierarchy. The cache that is closest to the processor core is considered to be the highest-level or “L1” cache in the cache hierarchy and is generally the smallest and fastest of the caches. Other generally larger and slower caches are then placed in descending order in the hierarchy starting with the “L2” cache and so forth. When a processor core attempts to read or write a location in main memory, the cache follows certain policies for storing and discarding data. For example many caches follow a cache line replacement policy called least-recently-used (LRU) in which a cache line is discarded based on having been the last accessed at an earlier point in time compared to other cache lines.

Known caches contain multiple status bits to indicate the status of the cache line in the cache. The status bits are used to maintain data coherency throughout the system and to track what memory addresses are valid. When a processor core sends a read or write request for data at a memory address to an LI cache, the cache first checks to see if the memory address has been allocated to the cache. If the LI cache contains the memory address, the result is referred to as a cache hit, otherwise it is referred to as a cache miss. When a cache miss occurs, typically the next tower level cache associated with the processor core is checked. Successively lower levels are checked until all associated caches result in a cache miss or the desired memory address is found. However, each cache access takes up time and reduces overall processing speed. If the access results in a cache miss on all levels of the cache hierarchy, the data at the requested memory address must be retrieved from main memory, which results in a read or write access that takes longer than if the cache line had been allocated to a cache.

Additionally, a lower level cache typically enforces an inclusivity policy with regards to the higher level caches. In multiple processor core systems that utilize local L1 caches and a shared L2 cache, a strict inclusivity policy requires that cache lines stored within any L1 cache are also stored within the L2 cache. However, maintaining a strict inclusivity policy requires the L2 cache to check all L1 caches in the system before replacing a cache line, and to invalidate the cache line in all L1 caches that have copies of the cache line, even though the processor cores may use the cache line again in the future. These extra operations reduce performance and increase power consumption.

### BRIEF DESCRIPTION OF THE DRAWINGS

FIG. 1 illustrates in block diagram form a portion of a multiple core microprocessor with multiple caches and cache levels of a cache level hierarchy.

FIG. 2 illustrates in block diagram form a portion of the L2 cache of FIG. 1.

FIG. 3 illustrates a flow chart of a method for implementing a lower level cache line replacement policy biased on cache line inclusion in a higher level cache.

In the following description, the use of the same reference numerals in different drawings indicates similar or identical items.

### DETAILED DESCRIPTION OF ILLUSTRATIVE EMBODIMENTS

Embodiments of a cache system and a processor with biased cache line replacement policies are described below. In one embodiment, at least one of the lower level caches enforces a cache line replacement policy biased at least in part on a cache line's inclusion in higher level cache. In a more particular embodiment, the lower level cache enforces a cache line replacement policy that replaces a cache line based in part on whether it is present in any of the higher level caches. For example, an L2 cache is shared between a multiple processor cores, in which each of the processor cores has its own local (dedicated) L1 cache. The L2 cache enforces a cache line replacement policy by selecting victim cache lines for replacement based in part on cache line inclusion in any one of the L1 caches and in part on another factor.

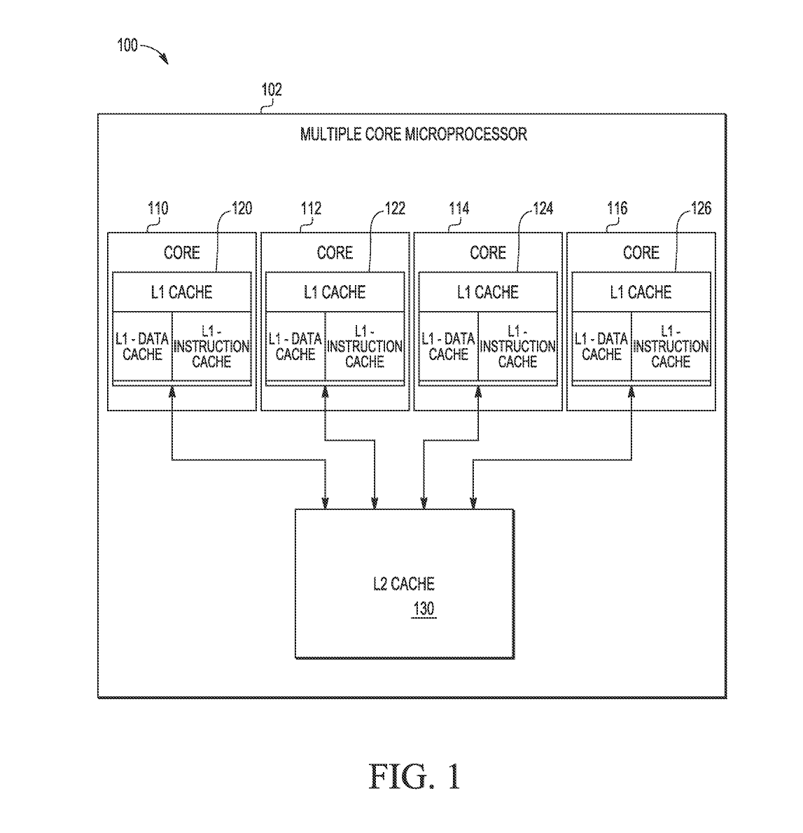

FIG. 1 illustrates in block diagram form a portion 100 of a multiple core microprocessor 102 with multiple caches and cache levels of a cache level hierarchy. Multiple core microprocessor 102 includes processor cores 110, 112, 114, and 116, and each of the processor cores has an associated L1 cache 120, 122, 124, and 126, respectively. Each of the LI caches 120, 122, 124, and 126 is at a first level (upper level) of the cache level hierarchy and has an associated instruction cache and a data cache. Multiple core microprocessor 102 also includes an L2 cache 130 at a second, lower level of the cache hierarchy. L2 cache 130 is a shared cache and is associated with each of the L1 caches 120, 122, 124, and 126.

When a processor core, such as processor core 110, sends a read or write request for a memory address, L1 cache 120 checks tags and status bits to see if L1 cache 120 contains the memory address in a valid state. If L1 cache 120 contains the memory address, L1 cache 120 completes the access. If the request was a read request, then L1 cache 120 returns the data at the requested memory address to processor core 110. If the request was a write request and the cache line is in the exclusive state (“E” bit set) or in the modified state (“M” bit set), L1 cache 120 updates the contents of the cache line and sets the NI bit to true if it wasn't set already, and completes the access by writing the data to the accessed part of the cache line. In the case of a writeback cache, when the line is later evicted from the L1 cache, perhaps long after the write request, then the modified data is written back to the next level in the cache hierarchy. However the biasing technique described herein is applicable to both writeback caches and write-through caches or any combination of writeback and write-through caches. However, if a cache miss occurs in L1 cache 120, L1 cache 120 probes L2 cache 130 to see if it has a copy of the cache line at the requested memory address. If L2 cache 130 contains the cache line, L2 cache 130 provides the corresponding data to L1 cache 120 and sets a status bit called an “inclusion bit” corresponding to L1 cache 120. If Li cache 120 is full, L1 cache 120 selects a victim cache line to replace with the memory address and corresponding data. When L1 cache 120 replaces the victim with the new cache line, L2 cache 130 clears the inclusion bit for the cache line corresponding to the victim, as the replaced victim is no longer present L1 cache 120. As used herein the “inclusion bits” are status bits which are used to indicate if the cache line is present in an L1 cache. In one embodiment, each cache line of L2 cache 130 has a set of inclusion bits, each inclusion bit associated with one of the L1 caches 120, 122, 124, or 126, and each inclusion bit is used to indicate if the cache line is present in the associated L1 cache. In another embodiment, each cache line of L2 cache 130 has a. single inclusion bit which indicates that the cache line is present in at least one of the L1 caches 120, 122, 124, or 126. It should also be understood that in some embodiments, inclusion bits may also be implemented as a field. Thus, it should be understood that while L2 cache 130 keeps track of which cache lines are included in which L1 caches 120, 122, 124, and 126 using individual inclusion bits, many other forms of inclusivity indicators may also be used.

Eventually, an access to L2 cache 130 results in a cache miss as well and the data at the accessed memory address will have to be retrieved from main memory. L2 cache 130 selects a victim cache line to replace with the accessed data and provides the accessed data to L1 cache 120 as described above. When L2 cache 130 selects a victim cache line to replace with the data, L2 cache 130 does so in part based on the state of the inclusion bits. L2 cache is biased to prefer to select a victim that is not present in any of L1 caches 120, 122, 124, and 126 or in the fewest number of L1 caches 120, 122, 124, and 126. L2 cache 130 is able to determine the presence of the cache line in an L1 cache by checking the inclusion bits. If any of the inclusion bits are set, then the cache line is present in at least one L1 cache 120, 122, 124, or 126 and L2 cache 130 exhibits a bias in favor of selecting another victim cache line.

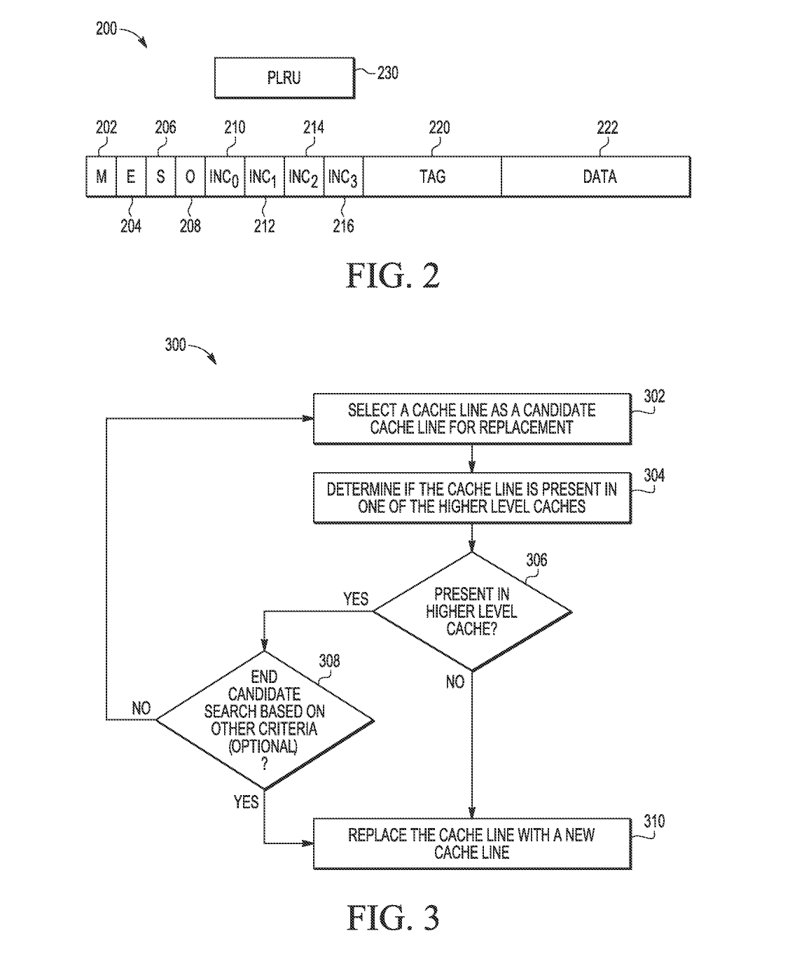

Because L2 cache 130 has a replacement policy biased by using the inclusion bits, L2 cache 130 is more likely to select victims that are not present in any L1 cache 120, 122, 124, or 126 and the cache lines, on average, remain in the L1 caches 120, 122, 124, and 126 longer, which reduces read write request time and improves the overall processing speed and. performance of multiple core microprocessor 102. More details as the implementation of possible biased cache line replacement policies are detailed with respect to FIG. 2 below,

FIG. 2 illustrates in block diagram form a portion of L2 cache 130 of FIG. 1 including a cache line 200 and a set of pseudo least recently used (PLRU) bits 230. L2 cache 130 implements the MOESI protocol with a pseudo least recently used (PLRU) cache line replacement policy with L1 cache inclusion biasing. It should be understood that other protocols, for example LRU, RRIP, MRU, Random, or ARC replacement policies, may be implemented in place of those shown in FIG. 2, while still implementing a cache line replacement policy biased on inclusion in higher level caches.

Cache line 200 includes status bits called modified (“NI”) 202, exclusive (“E”) 204, shared (“S”) 206, and owned (“O”) 208, While shown in FIG. 2 as individual bits, in an alternate embodiment these bits may be encoded. M bit 202 indicates that the cache line is present in cache 130 and has been modified (“is dirty”). M bit 202 is set, then L2 cache 130 writes the updated copy of the data into main memory before replacing the cache line. \f£ bit 204 is set then the cache line is present in L2 cache 130 but is unmodified (clean). If S bit 206 is set, the cache line is stored in other caches, such as one of L1 caches 120, 122, 124, or 126, and is unmodified.

L2 cache 130 also includes a set of PLRU bits 230 associated with cache line 200 which are shared between cache line 200 and other cache lines, not shown in FIG. 2, having the same index as cache line 200. As will be seen further below, cache line replacement can be biased against replacing an included cache line by altering the way the PLRU bits are used and updated, The PLRU bits 230 are used to implement the PLRU replacement policy. In one example, L2 cache 130 is an 8-way set associative cache system that includes sets of eight cache lines selected by a common index, and uses seven PLRU bits to point to the least recently used cache line. These PLRU bits may be labeled as “root”, “mid0”, “mid1”, “low0”, “low1”, “low2”, and “low3” to forma PLRU “tree” with 8 cache lines as leaves. Each PLRU tree resembles a pyramid with the root bit being the top level. In the example of a 7 PLRU bit tree, the root is a sole PLRU bit on the top level, the mid-level is formed of two PLRU bits (the mid0 and mid1 bits), and the low level consists of four PLRU bits (low0-low3) and the bottom level is formed of 8 cache lines.

The PLRU tree is traversed downward from the root during victim selection time much like a binary search tree in order to select a victim cache line. During victim selection time, L2 cache 130 selects between two branches at each level of the PLRU tree by following the branch that was least recently used. As the search progresses, each of the bits directs the victim search down the tree either to the right or left depending on whether or not the bit is set. For example, if a bit is set the search proceeds to the right. Once the PLRU tree is fully traversed the search ends at a cache line which is selected as the victim cache line and replaced. The PLRU tree is also updated regularly after a cache line is touched by a processor core, because the touched cache line is now the most recently used cache line. During the update the PLRU tree is traversed in reverse starting at the cache line on the bottom level and moving up to the root. As the PLRU tree is traversed upwards from a cache line, the PLRU bits are set to point away from the cache line that was last touched.

Cache line 200 also includes Tag 220 and Data 222. L2 cache 130 is an 8-way set associative cache, and tag 220 is the portion of an address that is used to select the cache line for a particular index and along with the tags of all other cache lines in the selected index to determine if a cache hit or miss occurs when L2 cache 130 receives a request. However note that the replacement mechanism described herein may be used with other types of caches, including fully associative caches.

Cache line 200 also contains inclusion bits 210, 212, 214, and 216. Each inclusion bit is associated with one of the Li caches 120, 122, 124, and 126 of FIG. 1. In the present embodiment, inclusion bit 210 is associated with L1 cache 120, inclusion bit 212 is associated with L1 cache 122, inclusion bit 214 is associated with L1 cache 124, and inclusion bit 216 is associated with L1 cache 126. Each of the inclusion bits 210, 212, 214, and 216 indicate if cache line 200 is present in the associated Li cache 120, 122, 124, and 126 and L2 cache 130 used the inclusion bits to perform biasing of the cache line replacement policy. In an alternative embodiment, inclusion bits 210, 212, 214, and 216 may be replaced by an encoded field or by a single bit that indicates whether cache line 200 is included in any of the L1 caches.

During operation, L2 cache 130 eventually becomes full with valid cache lines and must replace a cache line by selecting a victim. In a first example, L2 cache 130 selects a cache line for replacement based on a policy called “Avoid L1V”, which is in turn based in part on PLRU policy and in part on cache line inclusion in any of the L1 caches 120, 122, 124, and 126. In this example, L2 cache 130 works by enforcing a modified (“biased”) PLRU update. During the update period and after flipping (i.e. inverting) the PLRU bits based on if a cache line was touched, L2 cache 130 conditionally flips every PLRU bit, such that the PLRU bits point away from a way if the next candidate cache line in the PLRU tree has at least one of the inclusion bits 210, 212, 214, or 216 set. However, if during the conditional flip both ways result in a candidate cache line with at least one of inclusion bits 210, 212, 214, and 216 set, then the PLRU bits remain unchanged. In one particular embodiment, L2 cache 130 conditionally flips the PLRU bits based on which candidate cache line has the most inclusion bits 210, 212, 214, and 216 set, i.e. is present in the most L1 caches 120, 122, 124, and 126.

In a second example, L2 cache 130 selects a cache line for replacement on a policy called “Skip L1V”, which is based in part on the PLRU policy and in part on the cache line's inclusion in any of the L1 caches 120, 122, 124, or 126. In this example, L2 cache 130 works by enforcing the policy at victim selection time instead of during PLRU update time. During the period of time for victim selection, L2 cache 130 checks the PLRU bits and if the PLRU bits point to a cache line which has at least one inclusion bit 210, 212, 214, or 216 set, then L2 cache 130 skips the candidate cache line and selects the next candidate cache line as the victim and replaces it. L2 cache 130 selects the next candidate cache line by choosing the line that would have been picked if PLRU bit 0 (the trunk of the decision tree) was inverted. If the next candidate also has an inclusion bit set, L2 cache 130 selects the first candidate. In an alternate embodiment, L2 cache 130 could select the next candidate cache line as the one selected after the PLRU bit 0 was inverted regardless of whether it has an inclusion bit set. Again, victim selection is biased against a cache line included in a higher level cache. By biasing the selection in this manner, L2 cache 130 avoids the painstaking process of checking a much larger candidate set of cache lines, white gating most of the benefit of avoiding replacement of included cache lines. In an alternative embodiment, L2 cache 130 may continue to skip candidate cache lines following the first inversion of the PLRU bit 0, if the next candidate cache lines also have at least one inclusion bit 210, 212, 214, or 216 set by inverting PLRU bits 218, consecutively, until all PLRU bits 218 are inverted or a victim not present in any of the L1 caches 120, 122, 124, or 126 is selected.

In a third example L2 cache 130 selects a victim cache line for replacement by enforcing a policy, which is based in part on a re-reference interval prediction (RRIP) policy and in part on the cache line's inclusion in any of the L1 caches 120, 122, 124, and 126. In this example, L2 cache 130 enforces the biased RRIP policy at victim selection time. During normal victim selection with RRIP, the way with the oldest age is selected. If multiple ways have the same age, the lowest numbered way is selected. To implement a biased RRIP victim selection, L2 cache 130 uses two copies of the victim selection logic. One copy of the victim selection logic determines a victim without consideration of the inclusion bits, while the other copy determines a victim by only considering those ways which do not have an inclusion bit set.

Each copy of the victim selection logic thus produces a victim way (“A.way” and “B.way”) and an age for the corresponding victim way (“A.age” and “B.age”), B.way is chosen as the victim if both .A.age is equal to B.age, and either B.age is greater than 0 or B.way is not 0. Otherwise, the A.way is chosen as the victim. The biased RRIP policy effectively doubles the victim selection logic, but produces a result almost as quickly as the unbiased RRIP policy.

It should be understood that the policies described above are examples of biased cache line replacement polices but other cache line replacement policies (such as MRU, Random, or ARC among others) may also be biased using inclusion bits 210, 212, 214, and 216 at either update time or victim selection time.

FIG. 3 illustrates a flow chart of a method 300 for implementing a lower level cache line replacement policy biased on cache line inclusion in a higher level cache. At step 302, a L2 cache selects a cache line as a candidate cache line for replacement. As discussed above the L2 cache may utilize various forms of biased replacement policies, such as the Avoid L1V, Skip L1V, or biased RRIP polices to select a candidate cache line for replacement. Proceeding to step 304, the L2 cache determines if the cache line is present in one of the higher level caches, the L1 caches. The L2 cache may determine if the cache line is present in a L1 cache by checking the L1 inclusion bits for each candidate cache line. It should be noted that step 304 may be included in step 302. For example, in the biased RRIP policy, described above, the L2 cache determines if the cache line is present any of the L1 caches during the victim selection process by adjusting the age of cache lines if at least one of the inclusion bits is set.

Advancing to step 306, if the cache line is present in any of the higher level, L1, caches then method 300 proceeds to 308, else method 300 proceeds to 310 and the L2 cache replaces the cache line with a new cache line. If method 300 proceeded to 308, the L2 cache may end the candidate cache line search based on criteria other than a cache lines presence in a L1 cache and move to 310 to again replace the cache line. For example, in the Skip L1V policy, described above, the L2 cache may replace the second candidate cache line, the cache line selected after the PLRU bit 0 is inverted, regardless of the second candidate cache line's inclusion in a L1 cache. In another example, again in the Skip L1V policy the L2 cache may have inverted all of the PLRU bits and replace the final candidate cache line even if the inclusion bits are set. However if the L2 cache does not want to end the search based on other criteria then, the L2 cache selects a new candidate cache line and method 300 repeats.

Although the present invention has been described with reference to (preferred embodiments, workers skilled in the art will recognize that changes may be made in form and detail without departing from the scope of the invention.

What is claimed is:

1. A cache system comprising:
a plurality of first caches at a first level of a cache hierarchy; and
a second cache at a second level of the cache hierarchy coupled to each of the plurality of first caches, the second level lower than the first level, wherein the second cache enforces a cache line replacement policy in which the second cache selects a cache line for replacement based in part on whether the cache line is present in one or more of the plurality of first caches and in part on another factor.

2. The cache system of claim 1, wherein the second cache comprises:
a plurality of cache lines, each cache line of the plurality of cache lines having a field that indicates whether the cache line is present in any of the plurality of first caches.

3. The cache system of claim 2, wherein the field comprises a plurality of inclusion bits, each of the inclusion bits corresponding to one of the plurality of first caches.

4. The cache system of claim 1, wherein each of the plurality of first caches is at L1 of the cache hierarchy and the second cache is at L2 of the cache hierarchy.

5. The cache system of claim 1, wherein the cache line replacement policy further comprises a pseudo least recently used policy.

6. The cache system of claim 1, wherein the cache line replacement policy biases the cache line for replacement at victim selection time.

7. The cache system of claim 1, wherein the cache line replacement policy further comprises a skip policy.

8. The cache system of claim 1, wherein the cache line replacement policy further comprises a re-reference interval prediction policy.

9. The cache system of claim 8, wherein the second cache determines a first victim as an oldest cache line among a set of cache lines without consideration of whether the first victim is present in one or more of the plurality of first caches, determines a second victim as a cache line among the set of cache lines that is not present in one or more of the plurality of first caches, and selects the cache line for replacement between the first victim and the second victim.

10. The cache system of claim 1, wherein the cache line replacement policy selects the cache line in part based on a length of time the cache line is present in the first cache.

11. A processor comprising:
a plurality of processor cores;
a plurality of first caches at a first level of a cache hierarchy, each of the plurality of first caches corresponding to one of the plurality of processor cores;
a second cache at a second level of the cache hierarchy, the second level lower than the first level; and
wherein the second cache enforces a cache line replacement policy in which the second cache selects a cache line for replacement based in part on whether the cache line is present in any of the plurality of first caches and in part on another factor,

12. The processor of claim 11, wherein the second cache is associated with all of the plurality of processor cores.

13. The processor of claim 12, wherein the second cache comprises:
a plurality of cache lines, each cache line having a plurality of inclusion bits indicative of whether the cache line is present in a corresponding one of the plurality of first caches.

14. The processor of claim 13, wherein the second cache selects the cache line if none of the inclusion bits indicate the cache line is present in the corresponding one of the plurality of first caches.

15. The processor of claim 11, wherein the second cache selects the cache line at victim selection time and skips a candidate cache line if it is present in any of the plurality of the first caches.

16. A method for cache line replacement in a lower level cache comprising:
selecting a first cache line of the lower level cache as a candidate cache line for replacement;
determining whether the first cache line is present in any one of a plurality of higher level caches;
if the candidate cache line is not present in any one of the plurality of higher level caches, replacing the first cache line with a new cache line; and
if the candidate cache line is present in at least one of the plurality of higher level caches, selectively replacing a second cache line with the new cache line.

17. The method of claim 16, wherein the selecting the candidate cache line comprises selecting the candidate cache line based on a pseudo least recently used policy.

18. The method of claim 16, wherein the selecting the candidate cache line comprises selecting the candidate cache line based on a skip policy.

19. The method claim 16, wherein the selecting the candidate cache line comprises selecting the candidate cache line based on a re-reference interval prediction policy.

20. The method of claim 16, wherein the selecting the candidate cache line comprises selecting the candidate cache line based on a length of time the candidate cache line has been present in the higher level cache.
